(19) United States
(12) Patent Application Publication
(10) Pub. No.: US 2002/0197065 A1
(43) Pub. Date: Dec. 26, 2002

(54) Apparatus and method of recording/reproducing digital broadcast data

(75) Inventors: Sung Ryun Cho, Seoul (KR); Jea Yong Yoo, Seoul (KR); Kang Soo Seo, Kyungoi-do (KR); Byung Jin Kim, Kyungoi-do (KR)

Correspondence Address: LEE & HONG, 11th Floor, 221 N. Figueroa Street, Los Angeles, CA, 90012, US

(73) Assignee: LG Electronics Inc.

(21) Appl. No.: 10/176,099

(22) Filed: Jun. 20, 2002

(30) Foreign Application Priority Data
Jun. 21, 2001 (KR) 2001-35396

(51) Int. Cl. H04N 5/76

(52) U.S. Cl. 386/111; 386/131

(57) ABSTRACT

The present invention relates to method and apparatus of recording/reproducing a non-MPEG formatted digital TV broadcast signal on/from a writable medium. The present recording method, when a digital TV broadcast signal composed of DirecTV transport packets is received, collects DirecTV transport packets as adding receiving time information to each packet optionally, slices the collected packets into 184-byte stream pieces, composes a Transport Packet defined in MPEG standard with each piece, and writes a series of Transport Packets on a recording medium. The present method can record a non-MPEG type of transport stream in MPEG recording format and reproduce the recorded transport stream to original DirecTV transport stream, whereby an applicability of a digital recorder is improved.

### BACKGROUND OF THE INVENTION

1. Field of the Invention

The present invention relates to method and apparatus of recording a non-MPEG formatted digital TV broadcast signal on a writable medium such as a writable high-density digital versatile disk (called ‘HD-DVD’ hereinafter). The present invention further relates to method and apparatus of reproducing MPEG-formatted data stream, in which non-MPEG formatted packets are encapsulated, from a recording medium.

2. Description of the Related Art

FIG. 1 is an illustrative format of MPEG2 (Moving Picture Experts Group 2) transport stream. An MPEG2 transport stream consists of a series of Transport Packets (abbreviated to ‘M-TP’ hereinafter). An M-TP, 188-byte long, consists of 4-byte prefix, namely, header and 184-byte payload, which includes adaptation field optionally as shown in FIG. 1, or 184-byte adaptation field. The adaptation field includes program clock reference (PCR) used for system clock synchronization. The 4-byte header includes a sync byte (SB), a transport error indicator (TEI), a packet ID (PID), and so forth.

An MPEG2 transport stream structured as above is adopted as standard in most of digital TV broadcast systems.

Therefore, a digital video recorder for recording digital TV broadcast programs is likely to be developed to record digital TV broadcast programs transmitted in the form of M-TPs. According to a provisional standard thereof, a digital video recorder records M-TPs sequentially as they are received while adding 4-byte arrival time stamp (TS) to each M-TP or records M-TPs sequentially as they are received without any TS. And, in reproduction mode, it reads recorded M-TPs and transmits them one after another to a picture presenting machine such as a digital TV set based on each interval between adjacent TSs added therein.

However, there are several digital TV broadcast systems not adopting MPEG format as standard. DirecTV is one of them. FIG. 2 is an illustrative transport stream format defined in DirecTV. A DirecTV transport stream consists of a series of transport packets (abbreviated to ‘D-TP’ hereinafter). A D-TP, 130-byte long, consists of 2-byte prefix, namely, header and 128-byte transport block. A transport block consists of continuity counter (CC) of packets belonging to same service channel ID (SCID), a header designator (HD), and payload including chunks of auxiliary or MPEG data.

A 2-byte header includes a control flag indicating whether data is scrambled or not, the SCID, and so on. The DirecTV system has an RTS (Reference Time Stamp) type of packet, which is illustratively shown in FIG. 3, including 5-byte RTS. RTS packets are transmitted periodically at 10 Hz and the RTS is carried through an auxiliary data block (ADB).

Besides the stream format defined in the DirecTV system, there are a variety of stream formats other than MPEG format. The same as the DirecTV format, every packet unit of the various of stream formats is different in length from an M-TP defined in MPEG format.

Therefore, the digital video recorder developed to record MPEG-formatted data stream as explained before is not able to record non-MPEG formatted digital TV broadcast programs as received.

### SUMMARY OF THE INVENTION

It is an object of the present invention to provide method and apparatus of recording a non-MPEG formatted transport stream in recording format defined in the MPEG standard.

It is another object of the present invention to provide method and apparatus of reproducing a recorded data stream where non-MPEG formatted transport packets are encapsulated in MPEG-formatted transport packets and transmitting the reproduced data stream in an original non-MPEG format.

A method of recording digital broadcast signal in accordance with the present invention is characterized in that it comprises the steps of: receiving a digital broadcast signal composed of transport packets of a first format; making transport packets of a second format out of the received transport packets of the first format, a transport packet of the first format being different in length from that of the second format; and writing the transport packets of the second format on a recording medium.

A method of reproducing digital broadcast data from a recording medium in accordance with the present invention is characterized in that it comprises the steps of: reading a data stream from the recording medium and making transport packets of a second format out of the read data stream; making transport packets of a first format out of the transport packets of the second format, a transport packet of the first format being different in length from that of the second format; and transmitting the transport packets of the first format.

An apparatus of recording digital broadcast signal in accordance with the present invention is characterized in that it comprises a data converter receiving a digital broadcast signal composed of transport packets of a first format, and making transport packets of a second format out of the received transport packets of the first format, wherein a transport packet of the first format being different in length from that of the second format; and writing means writing the transport packets of the second format on a recording medium.

An apparatus of reproducing digital broadcast data from a recording medium in accordance with the present invention is characterized in that it comprises reading means reading a data stream from the recording medium and making transport packets of a second format out of the read data stream; and a data converter making transport packets of a first format out of the transport packets of the second format and transmitting the transport packets of the first format, wherein a transport packet of the first format being different in length from that of the second format.

### BRIEF DESCRIPTION OF THE DRAWINGS

The accompanying drawings, which are included to provide a further understanding of the present invention, illustrate the referred embodiments of the invention, and together with the description, serve to explain the principles of the present invention, and wherein:

FIG. 1 is an illustrative format of MPEG2 (Moving Picture Experts Group 2) transport stream;

FIGS. 2 and 3 are illustrative transport stream formats defined in DirecTV, one of digital TV broadcast systems;

FIG. 4 is a block diagram of the first embodiment of an apparatus recording digital TV broadcast programs in accordance with the present invention;

FIG. 5 is a schematically-drawn process of encapsulating DirecTV data stream in MPEG2 transport stream in accordance with the first embodiment of the present invention;

FIG. 6 is a block diagram of an apparatus reproducing data stream recorded in accordance with the first embodiment of the present invention;

FIG. 7 is a block diagram of the second embodiment of an apparatus recording digital TV broadcast programs in accordance with the present invention;

FIG. 8 is a schematically-drawn process of encapsulating DirecTV data stream in MPEG2 transport stream in accordance with the second embodiment of the present invention;

FIG. 9 is a block diagram of an apparatus reproducing data stream recorded in accordance with the second embodiment of the present invention;

FIG. 10 is a block diagram of the third embodiment of an apparatus recording digital TV broadcast programs in accordance with the present invention;

FIG. 11 is a schematically-drawn process of encapsulating DirecTV data stream in MPEG2 transport stream in accordance with the third embodiment of the present invention; and

FIG. 12 is a block diagram of an apparatus reproducing data stream recorded in accordance with the third embodiment of the present invention.

### DETAILED DESCRIPTION OF THE PREFFERRED EMBODIMENT

In order that the invention may be fully understood, a preferred embodiment thereof will now be described with reference to the accompanying drawings.

In all embodiments of the present invention, it is supposed that a non-MPEG stream format is one defined in DirecTV standard.

FIG. 4 is a block diagram of the first embodiment of an apparatus recording digital TV broadcast programs in accordance with the present invention.

The recording apparatus of FIG. 4 comprises a clock generator 10 synchronizing its 27 MHz oscillating clock with RTS time carried periodically by DirecTV stream; a counter 11 counting the 27 MHz clock to produce a 4-byte arrival TS; a TS inserter 13 reading the 4-byte TS in the counter 11 and inserting it in front of each 130-byte D-TP; a latch 12, capable of holding two or more latched TSs, latching TS read by the TS inserter 13; an MPEG2 TP mux 14 slicing a series of D-TPs with added TSs into 184-byte stream pieces and adding 4-byte eader to each 184-byte stream piece to produce a series of 188-byte TPs; a TS adder 18 adding a latched 4-byte TS by the latch 12 in front of each M-TP outputted from the MPEG2 TP mux 14; a recording DSP (Digital Signal Processor) 15 converting the output data from the TS adder 18 to writing signals suitable to disk record; and an optical pickup 16 forming mark/space patterns on a writable HD-DVD 100 in accordance with the writing signals.

The clock generator 10 synchronizes the 27 MHz internal clock with 5-byte RTS time which is received at 10 Hz through an ADB of a RTS packet as mentioned before. The counter 11 continuously counts the synchronized 27 MHz clock with four bytes, namely, 2³² modulo.

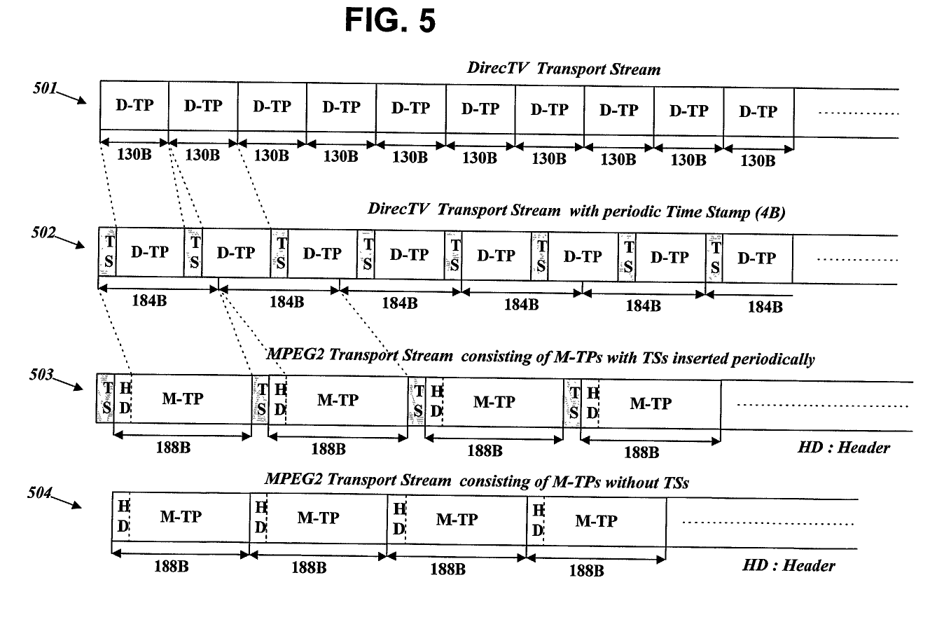

In recording mode, while receiving DirecTV transport stream 501, namely, a series of D-TPs shown in FIG. 5, the TS inserter 13 reads a count value of the counter 11 the moment a D-TP is received. The read 4-byte count value is then added as a TS in front of the arrived D-TP by the TS inserter 13. Consequently, the data stream 502 shown FIG. 5 is outputted from the TS inserter 13.

In the meantime, the read 4-byte TS by the TS inserter 13 is also latched in the latch 12 sequentially without overriding previous latched value or values.

The MPEG2 TP mux 14 slices the series of D-TPs with 4-byte TSs inserted therein into 184-byte stream pieces and then adds 4-byte header to each 184-byte stream piece to produce a series of 188-byte M-TPs. The TS adder 18 adds the 4-byte TS latched in the latch 12 in front of each 188-byte M-TP received from the MPEG2 TP mux 14. If two or more count values have been latched in the latch 12, the TS adder 18 uses the most lately latched value to add to a M-TP and deletes the others latched in the latch 12 to make latching room.

Consequently, a data stream 503 shown in FIG. 5 is outputted from the TS adder 18.

In the first embodiment, the TS may not be added to each 188-byte M-TP. In case of not adding TS, the TS adder 18 is removed in the structure of FIG. 4, and data stream is recorded in the format 504 of FIG. 5.

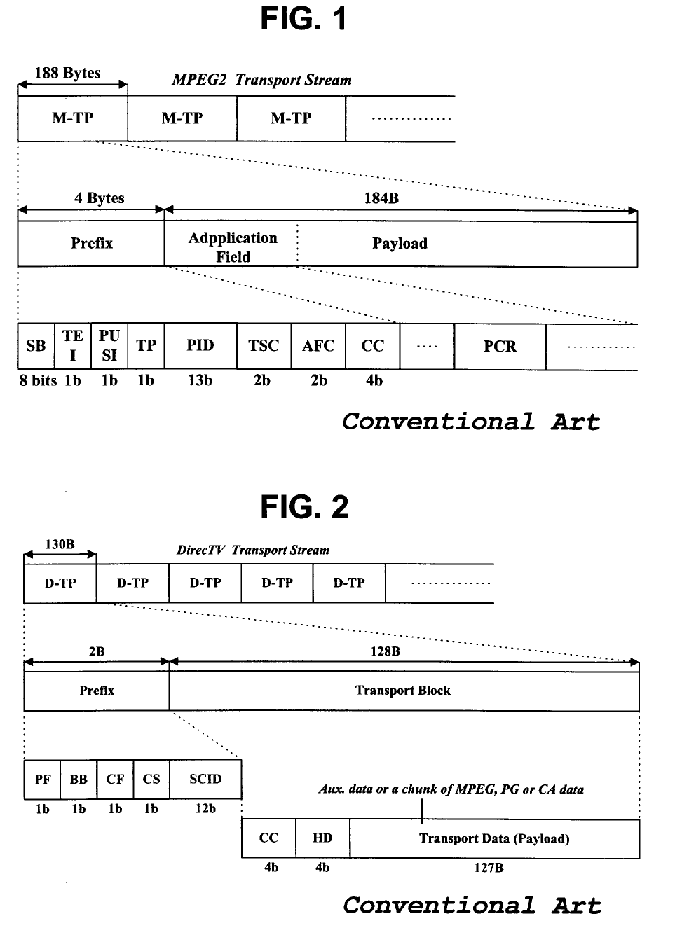

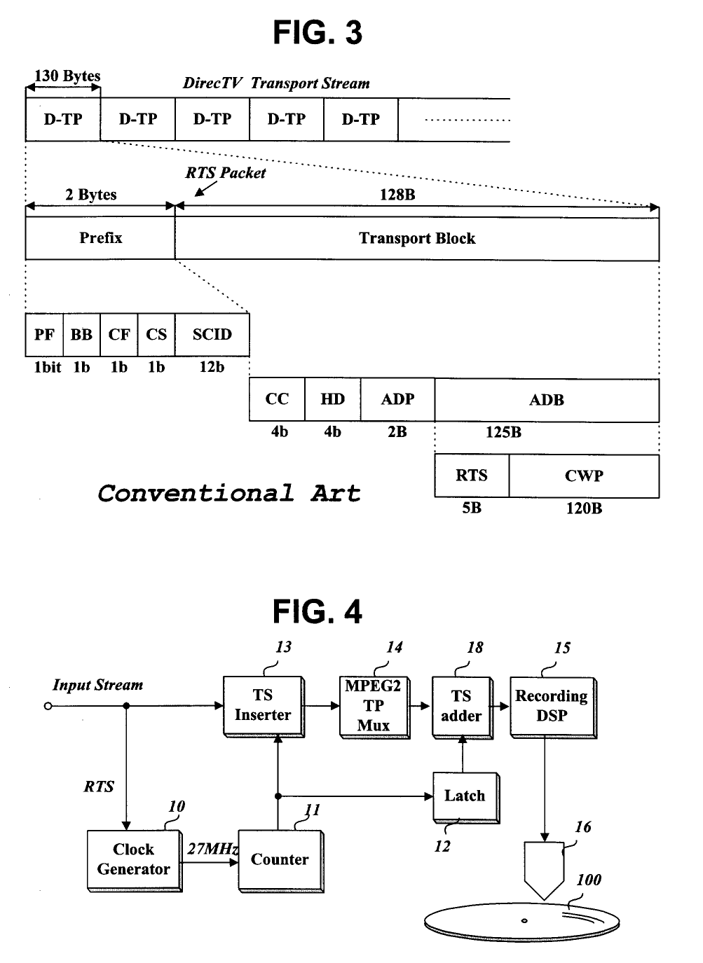

The header added to each 184-byte stream piece includes the SB, TEI, PID, and so forth as mentioned with reference to FIG. 1. Besides those fields, the header may contain additional information indicating that a packet or packets of non-MPEG format have been encapsulated in its payload field.

Consequently, the received DirecTV transport stream 501 is converted to MPEG2 stream format 503. The recording DSP 15 produces writing signals corresponding to the converted MPEG2 transport stream 503. The produced writing signals form successive mark and space patterns on a data recording area of the writable HD-DVD 100 through the optical pickup 16.

Next, apparatus and method of reproducing data stream recorded in accordance with the first embodiment are explained.

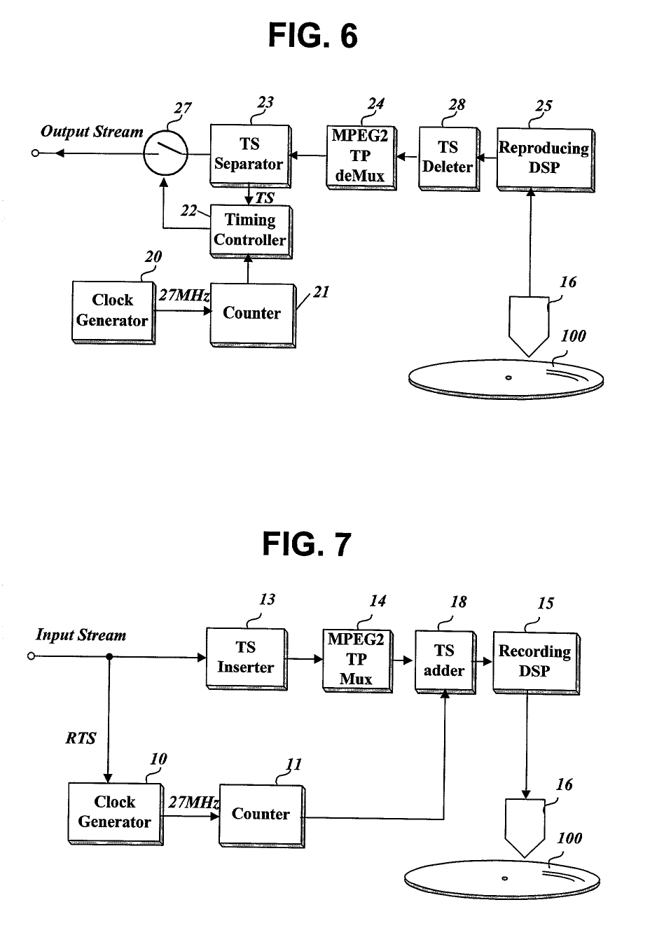

FIG. 6 is a block diagram of an apparatus reproducing data stream recorded in accordance with the first embodiment of the present invention.

The reproducing apparatus of FIG. 6 comprises an optical pickup 16 picking up signals recorded on the writable HD-DVD 100; a reproducing DSP 25 processing the picked up signals to restore original digital data stream; a TS deleter 28 slicing the restored digital data stream into 192-byte pieces and then deleting head 4-byte time information of each piece; an MPEG2 TP demux 24 dividing the output stream from the TS deleter 28 into 188-byte stream pieces, namely, M-TPs and then discarding 4-byte header of each M-TP; a TS separator 23 slicing data stream from the MPEG2 TP demux 24 into 134-byte stream pieces and then separating each stream piece into a 4-byte head TS and a 130-byte D-TP; a data holder 27 holding D-TPs from the TS separator 23 temporarily; and a timing controller 22 comparing a current count of a counter 21 counting a 27 MHz clock produced by a clock generator 20 with the 4-byte TS separated by the TS separator 23, and determining transmitting time of a held D-TP in the data holder 27 based on the comparison result.

In the apparatus of FIG. 6, the TS deleter 28 slices a digital data stream 503 outputted from the reproducing DSP 25 in 192-byte pieces and, then deletes 4-byte TS added in front of each M-TP. If the data stream from the reproducing DSP 25 is in format 504, the TS deleter 28 need not be included in the structure of FIG. 6.

The MPEG2 TP demux 24 divides the output stream from the TS deleter 28 into 188-byte stream pieces, namely, M-TPs and checks information written in 4-byte header of each M-TP to know whether non-MPEG transport stream is encapsulated in each M-TP. If the information is indicative of encapsulation of non-MPEG transport stream, the MPEG2 TP demux 24 outputs input stream after discarding the header of each M-TP. Therefore, the output stream of the MPEG2 TP demux 24 is in stream format 502 shown in FIG. 5.

The TS separator 23 slices the data stream from the MPEG2 TP demux 24 into 134-byte stream pieces and then separates each stream piece into a 4-byte head TS and a 130-byte D-TP which are delivered to the timing controller 22 and the data holder 27, respectively.

The timing controller 22 continues to monitor the time difference between a current count of the counter 21 and a memorized previous one at the time when a previous D-TP was transmitted. If the monitored time difference is equal to a TS difference between the just-delivered TS and a TS of the previous D-TP already sent, the timing controller 22 commands the data holder 27 to transmit a D-TP held at present.

Consequently, a series of 130-byte D-TPs recorded sequentially is reproduced and transmitted sequentially as it is received.

FIG. 7 is a block diagram of the second embodiment of an apparatus recording digital TV broadcast programs in accordance with the present invention. The recording apparatus of FIG. 7, which is for recording a series of D-TPs in the format of a series of M-TPs without adding TS to each D-TP, does not include two elements of the apparatus of FIG. 4. These two elements are the TS inserter 13 inserting TS in each D-TP and the latch 12 for matching time information between an M-TP and a D-TP encapsulated in the M-TP.

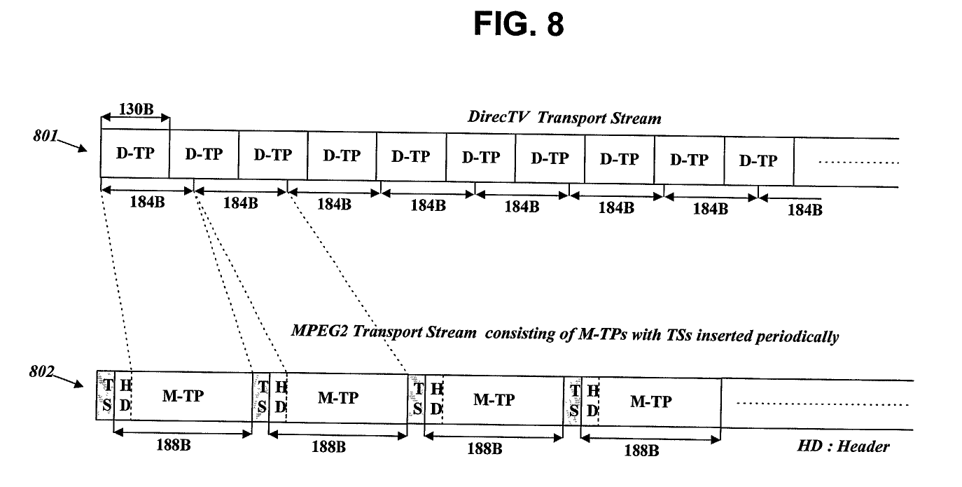

FIG. 8 is an illustrative format of DirecTV stream recorded by the recording apparatus of FIG. 7.

In the apparatus of FIG. 7, if a data stream 801, a series of D-TPs, is received, the MPEG2 TP mux 14 divides it into 184-byte stream pieces and adds 4-byte header to each stream piece to produce a series of M-TPs. The series of M-TPs is applied to the TS adder 18.

Whenever received bits are 188 bytes the TS adder 18 reads a current count in the counter 11 and adds the read count to the 188 bytes, namely, an M-TP. According to this operation, a data stream 802 of FIG. 8 is outputted from the TS adder 18. The data stream 802 is then recorded on the HD-DVD 100 through next writing process.

The other elements of which operations are not explained here conduct the same functions as they do in the first embodiment.

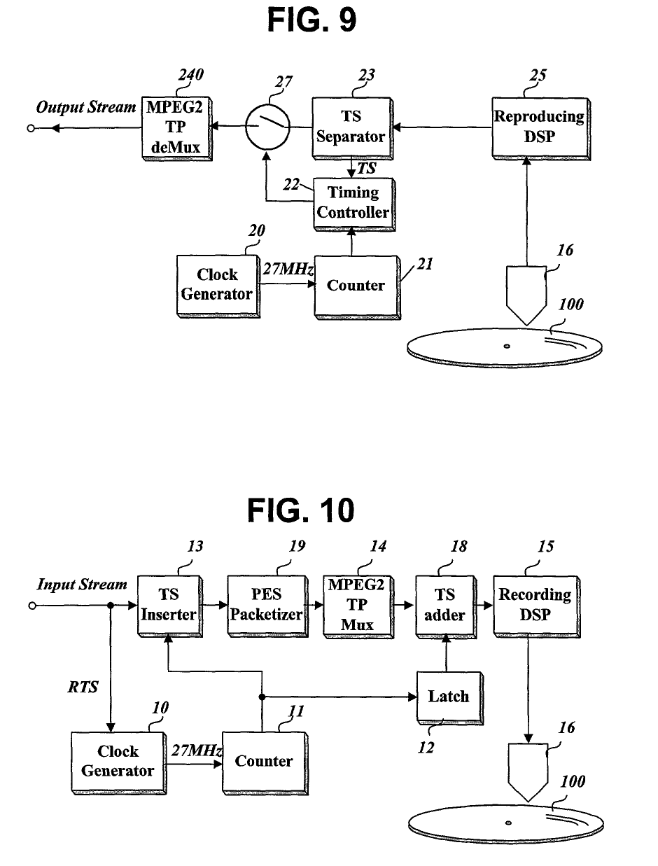

FIG. 9 is a block diagram of an apparatus reproducing data stream recorded in accordance with the second embodiment of the present invention. The structure of FIG. 9 is different from that of FIG. 6 in that FIG. 9 does not include the TS deleter 28 and the MPEG2 TP demux 240 is placed at the last output stage.

In the apparatus of FIG. 9, the TS separator 23 slices the data stream 802 of FIG. 8 outputted from the reproducing DSP 25 into 192-byte stream pieces and then separates each stream piece into a 4-byte head TS and a 188-byte M-TP which are delivered to the timing controller 22 and the data holder 27, respectively.

The MPEG2 TP demux 240 removes 4-byte header of each M-TP outputted from the data holder 27 and outputs a 130-byte D-TP encapsulated in 184-byte data. When the next M-TP is received the remaining 54 bytes are made to one D-TP with front 76 bytes of 184-byte data with no header of the next M-TP.

Consequently, a series of 130-byte D-TPs recorded sequentially is reproduced and transmitted sequentially as it is received in the format 801 of FIG. 8.

FIG. 10 is a block diagram of the third embodiment of an apparatus recording digital TV broadcast programs in accordance with the present invention. The recording apparatus of FIG. 10 is for recording a series of D-TPs in the format of a series of M-TPs via intermediate step of converting the series of D-TPs to PES (Packetized Elementary Stream) packets.

The apparatus of FIG. 10 further comprises, in comparison with the structure of FIG. 4, a PES packetizer 19 recomposing a data stream of D-TPs to a series of PES packets. The other elements conduct the same functions as corresponding elements of the apparatus of FIG. 4 do.

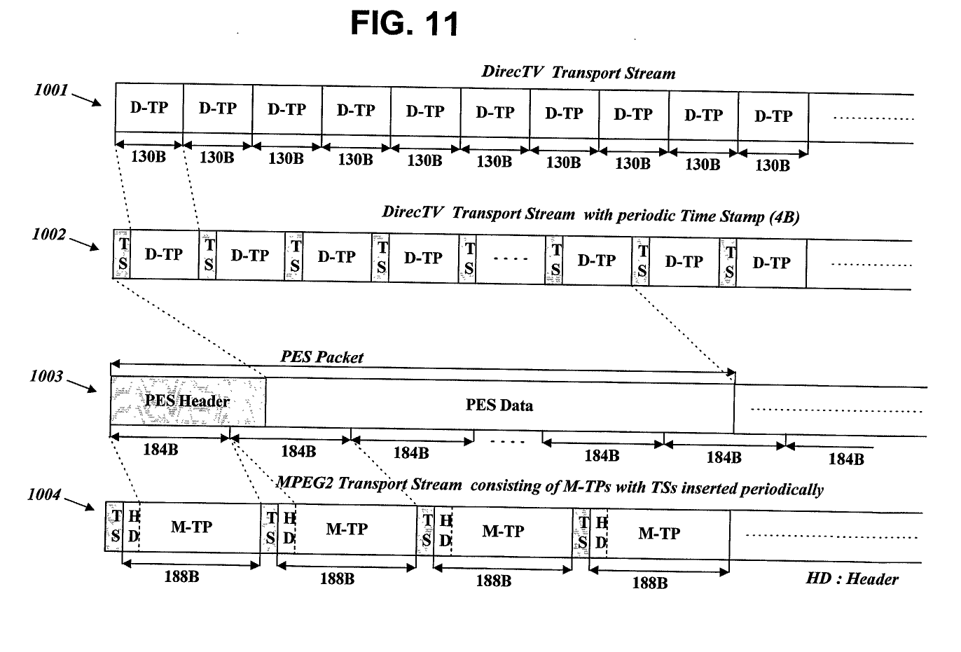

FIG. 11 is an illustrative format of DirecTV stream recorded by the recording apparatus of FIG. 10.

In the apparatus of FIG. 10, if a data stream 1001, a series of D-TPs, is received, the TS inserter 13 inserts TS in front of each D-TP, as a result, a data stream 1002 with TSs is outputted from the TS inserter 13. The data stream 1002 is then converted to PES packets by the PES packetizer 19.

In the PES packetizing process, some of 130-byte D-TPs and 4-byte TSs inserted therein are written in a PES data area. The length of a PES packet, namely, both of PES header and PES data is written in a PES header, and especially, the information indicating that a non-MPEG transport stream is encapsulated in PES data is written in a PES header.

The series of PES packets 1003 constructed as above is applied to the MPEG2 TP mux 14. Then, subsequent processes are conducted the same as done by the first embodiment, as a result, the data stream having format shown in 1004 of FIG. 11 is recorded on a data recording area of the HD-DVD 100.

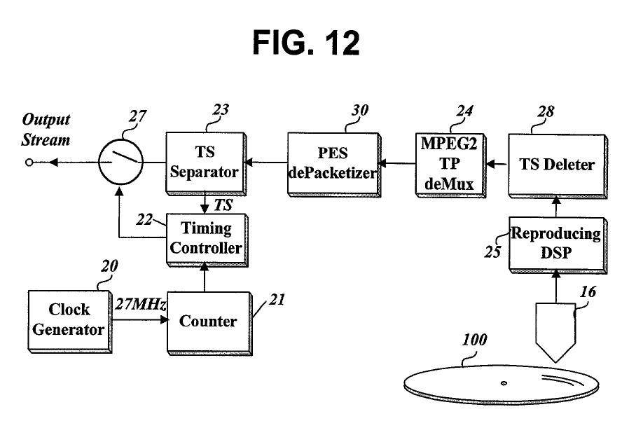

FIG. 12 is a block diagram of an apparatus reproducing data stream recorded in accordance with the third embodiment of the present invention. The structure of FIG. 12 is different from that of FIG. 6 in that FIG. 12 further includes a PES depacketizer 30 placed between the MPEG2 TP demux 24 and the TS separator 23. All elements excluding the PES depacketizer 30 conduct the same functions as they do in the first embodiment of FIG. 6.

The MPEG2 TP demux 24 removes 4-byte TS and 4-byte M-TP header from every 192 bytes of a data stream reproduced from the HD-DVD 100. While restoring the data stream outputted from the MPEG2 TP demux 24 to a series of PES packets, the PES depacketizer 30 checks the PES header of each PES packet to know whether a non-MPEG transport stream is encapsulated in a PES packet. If a non-MPEG transport stream is encapsulated, the PES depacketizer 30 outputs only PES data to the TS separator 23 after discarding every PES header.

Then, subsequent processes are conducted the same as done by the apparatus of FIG. 6, as a result, a series of 130-byte D-TPs recorded sequentially is reproduced and transmitted sequentially as it is received in the format 1001 of FIG. 11.

The above-explained apparatus and method of recording/reproducing digital TV broadcast data on/from a recording medium can record any type of transport stream in a predetermined recording format and reproduce recorded transport stream to an original type of transport stream, whereby an applicability of a digital recorder is improved.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of recording digital broadcast signal, comprising the steps of:
(a) receiving a digital broadcast signal composed of transport packets of a first format;
(b) making transport packets of a second format out of the received transport packets of the first format, a transport packet of the first format being different in length from that of the second format; and
(c) writing the transport packets of the second format on a recording medium.

2. The method of claim 1, wherein said step (b) makes transport packets of the second format out of the received transport packets of the first format after adding receiving time information to each transport packet of the first format.

3. The method of claim 1, wherein said step (b) collects a plurality of transport packets of the first format, constructs one packet of a third format with the collected transport packets of the first format, and makes a plurality of transport packets of the second format with the constructed one packet of the third format.

4. The method of claim 3, wherein said step (b) collects a plurality of transport packets of the first format after adding receiving time information to each transport packet of the first format, constructs one packet of a third format with the collected transport packets of the first format, and makes a plurality of transport packets of the second format with the constructed one packet of the third format.

5. The method of claim 3, wherein a packet of the third format is a PES (Packetized Elementary Stream) packet defined in MPEG (Moving Picture Experts Group) standard.

6. The method of claim 1, wherein said step (c) writes the transport packets of the second format on a recording medium after adding time information to each transport packet of the second format.

7. The method of claim 1, wherein a transport packet of the second format includes a predetermined-sized header.

8. The method of claim 1, wherein a transport packet of the first format is a 130-byte packet defined in DirecTV, one of digital TV broadcast systems.

9. The method of claim 1, wherein a transport packet of the second format is a Transport Packet defined in MPEG (Moving Picture Experts Group) standard.

10. A method of reproducing digital broadcast data from a recording medium, comprising the steps of:
(a) reading a data stream from the recording medium and making transport packets of a second format out of the read data stream;
(b) making transport packets of a first format out of the transport packets of the second format, a transport packet of the first format being different in length from that of the second format; and
(c) transmitting the transport packets of the first format.

11. The method of claim 10, wherein said step (b) extracts data from each transport packet of the second format, removes predetermined-sized time information from the extracted data, and makes the transport packets of the first format with the remaining extracted data.

12. The method of claim 10, wherein said step (b) collects data from a plurality of transport packets of the second format, constructs a packet of a third format with the collected data, extracts data from the constructed packet of the third format, and makes the transport packets of the first format out of the extracted data.

13. The method of claim 12, wherein said step (b) collects data from the plurality of transport packets of the second format, constructs a packet of the third format with the collected data, extracts data from the constructed packet of the third format, removes predetermined-sized time information inserted in the extracted data at intervals, and makes the transport packets of the first format with the remaining extracted data.

14. The method of claim 13, wherein a packet of the third format is a PES (Packetized Elementary Stream) packet defined in MPEG (Moving Picture Experts Group) standard.

15. The method of claim 10, wherein said step (a) makes transport packets of the second format out of the read data stream after removing predetermined-sized time information inserted periodically in the data stream.

16. The method of claim 10, wherein a transport packet of the second format includes a predetermined-sized header.

17. The method of claim 10, wherein a transport packet of the first format is a 130-byte packet defined in DirecTV, one of digital TV broadcast systems.

18. The method of claim 10, wherein a transport packet of the second format is a Transport Packet defined in MPEG (Moving Picture Experts Group) standard.

19. An apparatus of recording digital broadcast signal, comprising:
a data converter receiving a digital broadcast signal composed of transport packets of a first format, and making transport packets of a second format out of the received transport packets of the first format, wherein a transport packet of the first format being different in length from that of the second format; and
writing means writing the transport packets of the second format on a recording medium.

20. An apparatus of reproducing digital broadcast data from a recording medium, comprising:
reading means reading a data stream from the recording medium and making transport packets of a second format out of the read data stream; and
a data converter making transport packets of a first format out of the transport packets of the second format and transmitting the transport packets of the first format, wherein a transport packet of the first format being different in length from that of the second format.
